(19) United States
(12) Patent Application Publication
(10) Pub. No.: US 2005/0117535 A1
(43) Pub. Date: Jun. 2, 2005

(54) Information transfer method, information transfer system, and base station

(76) Inventor: Petri Mahonen, Aachen (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/502,192

(22) PCT Filed: Jan. 31, 2003
(86) PCT No.: PCT/FI03/00080

(30) Foreign Application Priority Data
Feb. 1, 2002 (FI) 20020196

(51) Int. Cl. H04Q 7/00

(52) U.S. Cl. 370/328

(57) ABSTRACT

A method of routing transferable information in an information transfer system. The method comprises dividing the coverage area of at least one base station into information transfer zones, setting code families to the information transfer zones, the codes of the code families indicating the information transfer zone, selecting an information transfer zone for a transmission so as to optimize the transfer route of the transferable information towards a desired receiver, assigning a code to the transmission from the code family set to the selected information transfer zone, and routing the transferable information by means of the selected code.

### FIELD

The invention relates to a method of routing transferable information in an information transfer system, to an information transfer system, and to a base station.

### BACKGROUND

The popularity of various radio communication applications, such as the Internet or telephone systems, continues to increase, partly due to the change in the way of life that has taken place and is continuously taking place: people and information move more and more. As mobility increases, fixed telephone networks are no longer able to respond to information transfer needs. There is also an increasing need to create radio networks that change as the demand changes. Examples include what are known as ad hoc, structureless radio networks. These networks do not comprise an actual fixed base station, but mobile subscriber terminals are able to attend to the tasks of the base station, for example attend to routing transferable information. This has resulted in the need to develop an efficient method of routing information in a radio network having a changing topology.

The basic problem in code division multiple access (CDMA) systems is that the transmissions of the system use the same frequency resource and thus interfere with each other. Different prior art methods exist for reducing interference. In one method, the location of the receiver is found out by means of a positioning method, and directional antennas are used to direct transmission power towards the receiver, resulting in reduced power in other directions, i.e. to other subscriber terminals. On the other hand, several prior art methods and algorithms exist for routing telecommunication packets and connections based on the utilization of location information (coding geographical location coordinates or the like). These methods are generally known as georouting or geogasting. In prior art radio networks, the actual physical transmission direction, i.e. routing direction, of georouting is implemented by means of directional antennas. However, the problem arises from the size, weight and price of such an antenna arrangement, when the transmitter is a subscriber terminal, which should be as small, lightweight and competitively priced as possible.

### BRIEF DESCRIPTION

An object of the invention is to provide a method and an apparatus for implementing the method so as to efficiently route transferable information in a radio network having a changing topology. Another object of the invention is to provide a method and an apparatus for implementing the method that supports georouting in both static and changing networks. This is achieved by the method of routing transferable information in an information transfer system. The method of the invention, comprises dividing the coverage area of at least one base station into information transfer zones, setting code families to the information transfer zones, the codes of the code families indicating the information transfer zone, selecting an information transfer zone for a transmission so as to optimize the transfer route of the transferable information towards a desired receiver, assigning a code to the transmission from the code family set to the selected information transfer zone, and routing the transferable information by means of the selected code.

The invention also relates to a method of routing transferable information in an information transfer system. The method comprises dividing the coverage area of at least one base station into information transfer zones, setting code families to the information transfer zones, the codes of the code families indicating the information transfer zone, selecting an information transfer zone for a transmission so as to optimize the transfer route of the transferable information towards a desired receiver, assigning a code to the transmission from the code family set to the selected information transfer zone, routing the transferable information by means of the selected code, and determining the transmissions that each base station listens to.

The invention also relates to a base station for routing transferable information in an information transfer system. The base station comprises means for dividing the coverage area into information transfer zones, the base station comprises means for setting code families to the information transfer zones, the codes of the code families indicating the information transfer zone, the base station comprises means for selecting an information transfer zone for a transmission so as to optimize the transfer route of the transferable information towards a desired receiver, the base station comprises means for assigning a code to the transmission from the code family set to the selected information transfer zone, and the base station comprises means for routing the transferable information by means of the selected code.

The invention also relates to a base station for routing transferable information in an information transfer system. The base station comprises means for dividing the coverage area into information transfer zones, the base station comprises means for setting code families to the information transfer zones, the codes of the code families indicating the information transfer zone, the base station comprises means for selecting an information transfer zone for a transmission so as to optimize the transfer route of the transferable information towards a desired receiver, the base station comprises means for assigning a code to the transmission from the code family set to the selected information transfer zone, the base station comprises means for routing the transferable information by means of the selected code, and the base station comprises means for determining the transmissions to be listened to.

The invention also relates to a telecommunication system, in which system transferable information is routed. The system comprises means for dividing the coverage area into information transfer zones, the system comprises means for setting code families to the information transfer zones, the codes of the code families indicating the information transfer zone, the system comprises means for selecting an information transfer zone for a transmission so as to optimize the transfer route of the transferable information towards a desired receiver, the system comprises means for assigning a code to the transmission from the code family set to the selected information transfer zone, and the system comprises means for routing the transferable information by means of the selected code.

The invention also relates to a telecommunication system, in which system transferable information is routed. The system comprises means for dividing the coverage area into information transfer zones, the system comprises means for setting code families to the information transfer zones, the codes of the code families indicating the information transfer zone, the system comprises means for selecting an information transfer zone for a transmission so as to optimize the transfer route of the transferable information towards a desired receiver, the system comprises means for assigning a code to the transmission from the code family set to the selected information transfer zone, the system comprises means for routing the transferable information by means of the selected code, and the system comprises means for determining the transmissions to be listened to.

The preferred embodiments of the invention are described in the dependent claims.

The invention is based on dividing the coverage area of the transmitting device, i.e. the audibility range of the antenna into information transfer zones. A code family, composed of available codes, is assigned to each information transfer zone. The codes are selected for the code families so that the different code families are mutually orthogonal. The codes inside the code families are also preferably mutually orthogonal. The location of the receiver is positioned and the transmission is directed towards the receiver via different nodes, i.e. devices serving as routers, e.g. base stations, in such a manner that the route is as suitable for the situation as possible, i.e. for instance the fastest or the one requiring the least transmission power in each node.

The method and device of the invention provide a plurality of advantages. The method of the invention achieves improved routing efficiency, particularly in a network having a changing topology. The invention improves routing efficiency also in systems wherein base stations or devices serving as base stations are not controlled by the base station controller. The invention also improves the efficiency and speed of georouting by bringing the support of the physical layer to georouting in networks based on code division multiple access (CDMA).

### LIST OF FIGURES

In the following, the invention will be described in detail in connection with preferred embodiments with reference to the accompanying drawings, in which

FIG. 1 shows an example of a telecommunication system,

FIG. 2 shows a second example of a telecommunication system,

FIG. 3 shows a third example of a telecommunication system,

FIG. 4 shows a flow diagram,

FIG. 5 illustrates information transfer zones,

FIG. 6 illustrates routing,

FIG. 7 shows an example of a base station.

### DESCRIPTION OF THE EMBODIMENTS

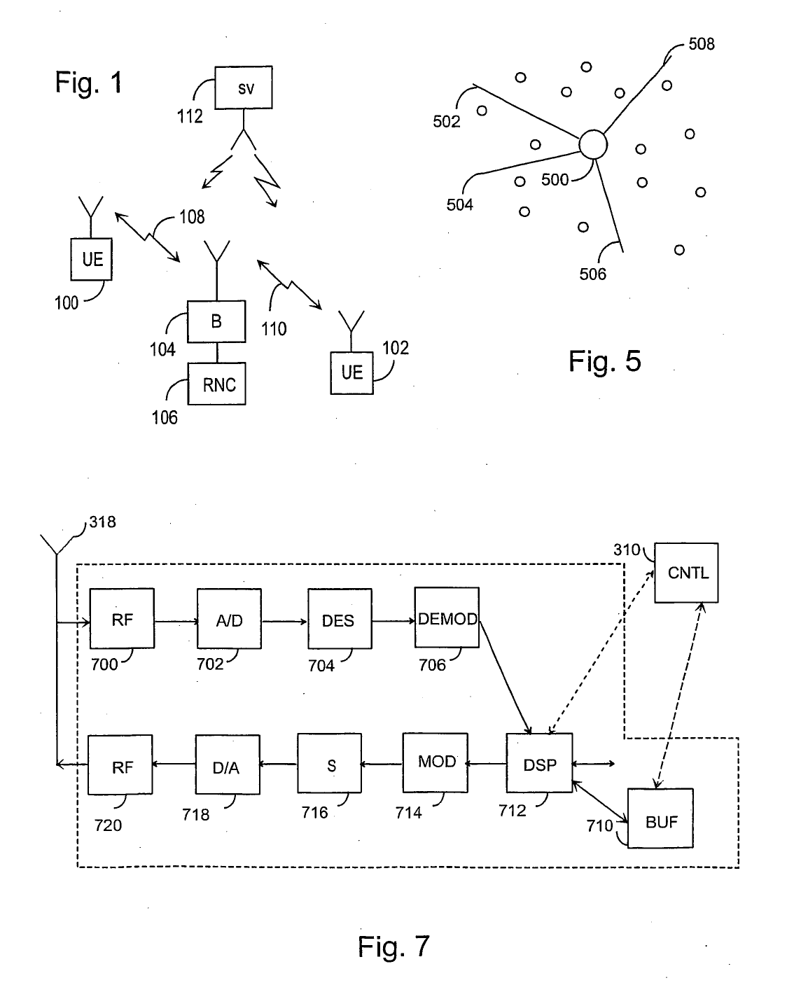

The present invention is usable in various communication systems, such as cellular radio systems. For instance CDMA (Code Division Multiple Access), and hybrids of TDMA (Time Division Multiple Access) and CDMA systems are feasible. It is apparent to a person skilled in the art that the method of the invention is also applicable to systems using different modulation methods or air interface standards. FIG. 1 simplistically illustrates a digital information transfer system to which the inventive solution is applicable. Part of a UMTS cellular radio system is involved, comprising a base station B 104, which is in a bi-directional connection 108 and 110 to subscriber terminals 100 and 102, which may be fixedly placed, vehicle-mounted or portable terminals. The base station comprises transceivers, for example. There is a connection from the base station's transceivers to an antenna unit for implementing the bi-directional radio connection to a subscriber terminal. A subscriber terminal applicable as a base station may also serve as the base station.

The base station is also in connection to a radio network controller (RNC) 106, which switches the connections of the terminals to other parts of the network. The radio network controller controls, in a centralized manner, a plurality of base stations communicating therewith. The radio network controller comprises a group switching field used for switching speech and data and for combining signalling circuits. The base station system composed by a base station and a radio network controller also comprises a transcoder. The transcoder is usually situated as close as possible to a mobile switching centre (MSC), since this enables the transfer of speech in the format of the cellular radio network between the transcoder and the radio network controller, thus saving transfer capacity. A control unit in the radio network controller performs speech control, mobility management, gathering of statistics and signalling. It is to be noted that the method is also applicable in networks having no actual radio network controller. Such networks are generally called structureless networks.

The exemplary system of FIG. 1 also comprises one or more satellites 112, allowing the terrestrial part of the system to utilize the global positioning system (GPS). In this case, a locating unit, LMU, is arranged terrestrially, usually at a base station, for receiving GPS signals. The radio network controller or a part thereof usually controls the operation of the positioning units. The GPS method will be described in detail below.

A cellular radio system may also communicate with a public telephone network; the transcoder converting the different digital coding formats of speech used between the public telephone network and the cellular radio network into mutually compatible formats.

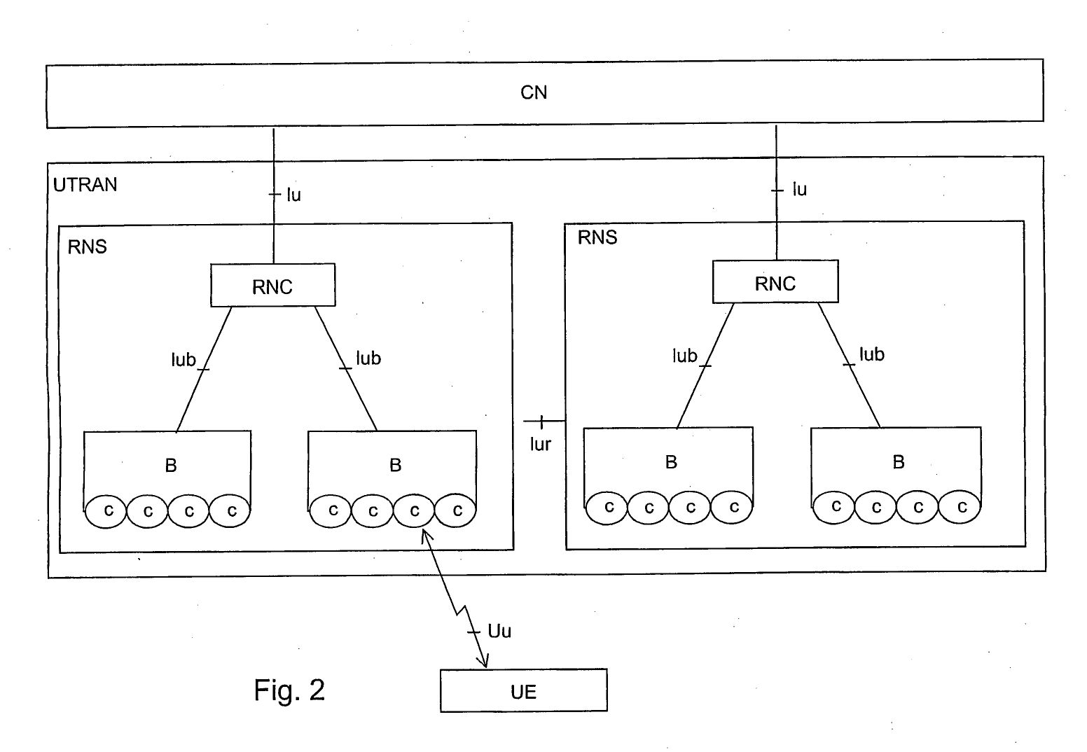

An example of the structure of the UMTS mobile telephone system will be described next with reference to FIG. 2. The UMTS system is an example of information systems applying code division multiple access. The main parts of the UMTS mobile telephone system include a core network CN, a universal terrestrial radio access network UTRAN, and user equipment UE. The interface between the CN and the UTRAN is called Iu, and the air interface between the UTRAN and the UE is called Uu.

The UTRAN is composed of radio network subsystems RNS. The interface between RNS:s is called Iur. The RNS is composed of a radio network controller RNC and one or more nodes B. The interface between the RNC and B is called Iub. In the figure, C denotes the coverage area of node B, i.e. a cell.

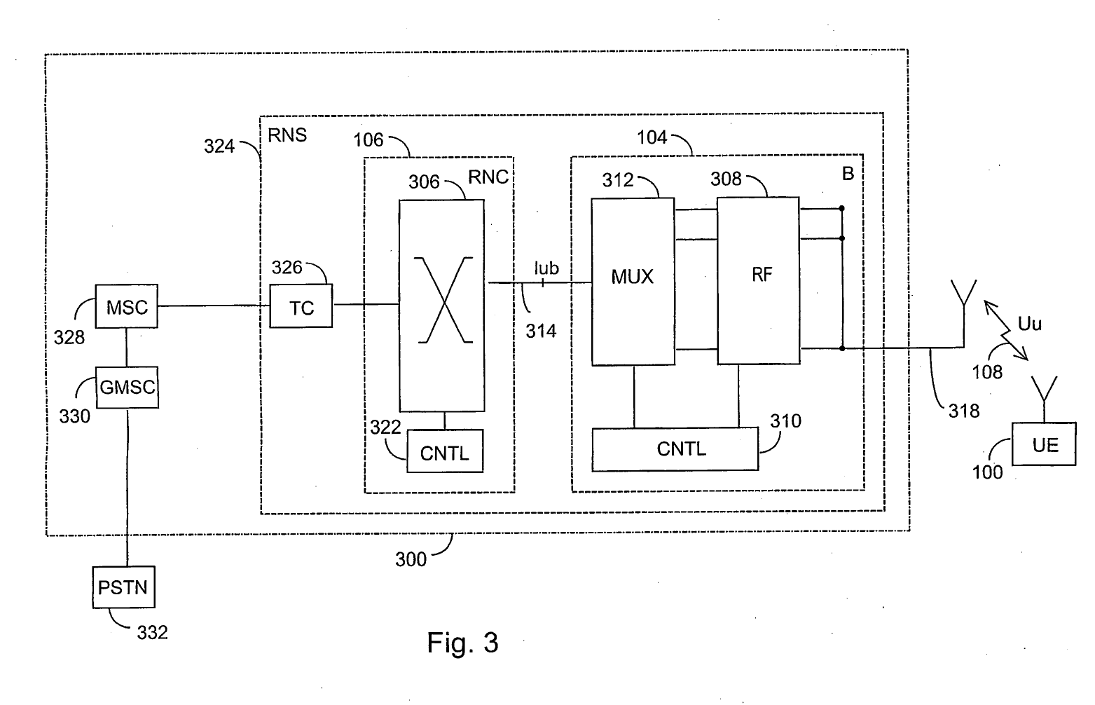

The description of FIG. 2 is on a quite general level, and therefore FIG. 3 shows a more detailed example of a cellular radio system. FIG. 3 only includes the most essential blocks, but it is apparent to a person skilled in the art that a conventional cellular radio network also includes other functions and structures that need not be described in detail herein. The details of a cellular radio system may differ from those shown in FIG. 3, but these differences are insignificant to the invention.

Accordingly, a cellular radio network typically comprises a fixed network infrastructure 300 and subscriber terminals 100. The fixed network infrastructure 300 comprises network parts, such as base stations 104. A base station corresponds to a node B in the previous figure. Several base stations 104 are controlled in a centralized manner by a radio network controller 106 communicating therewith. The base station 104 comprises radio frequency parts 308 and a multiplexer unit 312. In the example of FIG. 3, the radio frequency parts comprise both transmitter and receiver parts.

The base station 104 further comprises a control unit 310 for controlling the operation of the radio frequency parts 308 and the multiplexer 312. The traffic and control channels employed by the radio frequency parts 308 are placed with the multiplexer 312 to one transmission link 314. The transmission link 314 constitutes the interface Iub.

There is a connection from the radio frequency parts 308 of the base station 104 to an antenna unit 318, which implements the radio link 108 to the subscriber terminal 100. The structure of the frames transferred on the radio link 108 is specified system-specifically and called the air interface Uu.

The radio network controller 106 comprises a group switching field 306 and a control unit 322. The group switching field 306 is used to switch speech and data and to combine signalling circuits. A radio network subsystem 324 composed of the base station 104 and the radio network controller 106 also comprises a transcoder 326. The transcoder 326 is usually located as close as possible to a mobile switching centre 328, since this enables the transfer of speech in the format of the cellular radio network between the transcoder 326 and the radio network controller 106, thus saving transfer capacity.

The transcoder 326 converts the different digital speech coding formats used between the public telephone network and the radiotelephone network into mutually compatible formats, e.g. from the format of the fixed network into another format of the cellular radio network and vice versa. The control unit 322 performs speech control, mobility management, gathering of statistics, signalling, and control and management of resources.

FIG. 3 also shows a mobile switching centre (MSC) 328 and a gateway mobile switching centre (GMSC) 330, which attends to the connections of the mobile telephone system to the outside world, herein to the public telephone network 332.

Although the system examples described above are based on the UMTS system, it is apparent that the application of the invention is not restricted thereto.

In the present application, the term base station is used of a radio network device whose task is signal transmission to and signal reception from a subscriber terminal. In some networks, the subscriber terminals applicable as base stations may also act as base stations. In the present application, subscriber terminals acting also as base stations are called a base station when the intention is to bring forth the base station functions, in particular. A base station also refers to networks access points used in wireless local area networks (WLAN), for example.

The method is also applicable to ad hoc networking, i.e. structureless networking. In cellular radio networks, structureless networking means that a group of subscriber terminals generates a telecommunication network in an area that has no actual services of the network parts, such as base stations, of a cellular radio system, i.e. no cellular radio network coverage. In this case, the subscriber terminals transfer the information to be transferred from one device to another. Since typically at least some subscriber terminals are mobile, the topology of such a network usually changes with time. In structureless networks, all subscriber terminals may act as routers between other subscriber terminals. Structureless networks are usable for instance to temporarily increase capacity in congested areas. In structureless networking, prior art positioning methods may be used in positioning subscriber terminals, and some examples of these methods will be presented briefly below.

The method is also applicable in systems where base stations or devices acting as base stations are not controlled by a base station controller (for instance RNC). Such networks are sometimes called mesh networks. Networks not including base station controllers may be described as self-controlling networks in the sense that the base stations signal location, frequency and other information between themselves.

Some prior art positioning methods are described in detail next. Positioning methods are often divided into network-based and subscriber terminal-based methods. In subscriber terminal-based positioning methods, a subscriber terminal is able to perform measurements on signals transmitted by several different base stations. In the E-OTD method, which can be considered a hybrid of network-based and subscriber terminal-based methods, a subscriber terminal measures the interrelations of the reception times between signals received from different base stations. Since a radio network is not synchronic in practice, the synchronization difference between the base stations has to be defined, too. This can be implemented by receiving the signals transmitted by the base stations not only by the subscriber terminal but also in a location measurement unit (LMU) placed at a fixed known measuring point. The base station time delays are determined by means of the LMU, and the location of the subscriber terminal is then determined based on the geometric components obtained from the time delays. Consequently, the geometric time difference (GTD) is the observed time difference (OTD), from which the real time difference (RTD) is subtracted.

The location measurement unit LMU is preferably placed in connection with a base station, i.e. the LMU may be located in the base station itself, e.g. in its control part or as a device coupled to the base station, e.g. placed in a radio mast. In this case it is able to utilize the antennas and transceiver units of the base station, for example. However, the location measurement unit LMU may as well act as a separate unit communicating with the base station over a radio path.

In the E-OTD method, AT reporting may also be used. This can be implemented for example by placing a GPS receiver in the location measurement unit LMU and using the receiver to obtain what is known as the GPS time, i.e. the absolute time (AT), i.e. an AT value, which is then reported to a serving positioning centre (SMLC). In other words, the location measurement unit LMU reports, to the positioning centre, not only the RTD values of the base stations it measures, but also the reference value (Atref) of the absolute time of the location measurement area it determines. The E-OTD positioning method (Enhanced Observed Time Difference) is based on utilizing a location measurement unit (LMU) placed at a fixed known measuring point. The LMU is used to determine the time difference between the clocks of the base stations, i.e. the time delay after which the location of the subscriber terminal is determined based on the geometric components obtained from the time delays.

The GPS system (GPS, Global Positioning System) is a global positioning, navigation and time transfer system maintained by the US Department of Defence (DoD). In the GPS system, a receiver receives a signal transmitted by at least four orbital satellites, based on which the latitude, longitude and altitude of the location of the subscriber terminal can be calculated. In all, the system includes 24 orbital satellites controlled by means of land stations.

Positioning systems may be used to determine in which direction the information transfer is to be directed by the method of the invention, i.e. where the desired destination subscriber terminal is located. The location of the subscriber terminal may also be determined by other manners enabled by the system used in each particular case.

The position data allows telecommunication transmissions to be routed between several base stations geographically towards subscriber terminals. Prior art discloses various algorithms for using geographical location data for implementing routing algorithms.

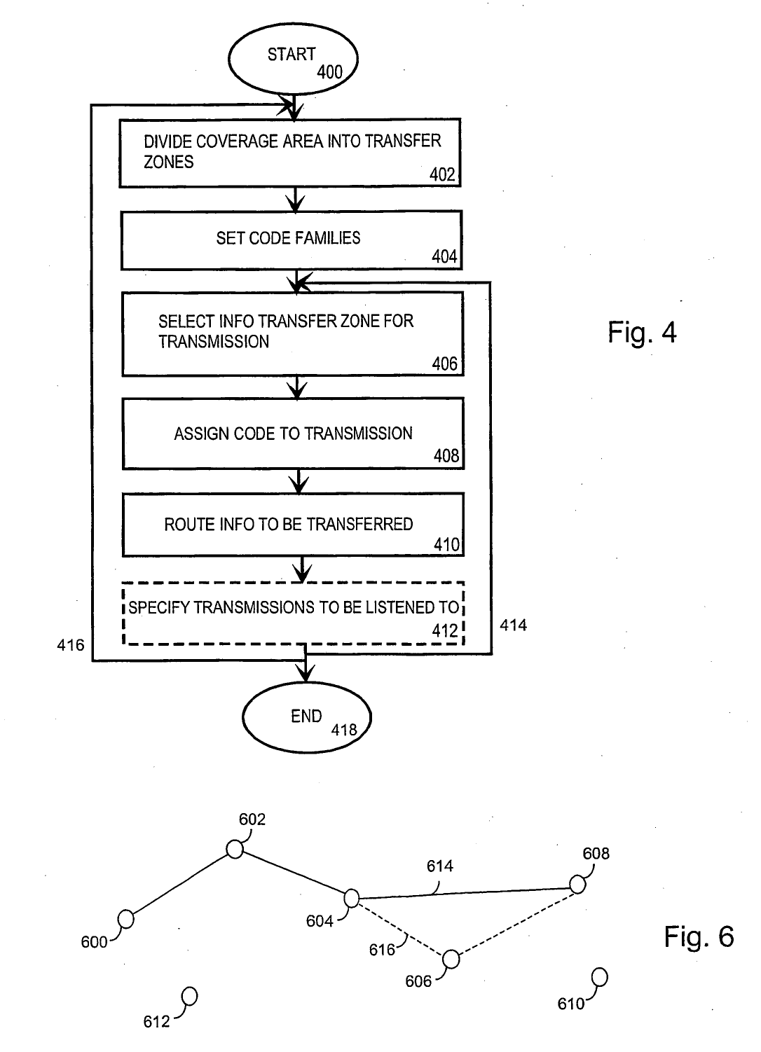

In the following, an embodiment of the invention will be described in detail by means of the flow diagram of FIG. 4. The method is particularly suited to systems where base stations act in a data network without a separate base station controller or to systems where subscriber terminals also attend to the tasks of base stations for creating a radio network. The method is applicable for instance in CDMA systems or wireless local are networks, i.e. WLAN networks. The execution of the method starts at block 400. Before or during the execution of the method, the location of the necessary radio devices is determined for instance by some prior art positioning method, which were described briefly above.

In block 402, the coverage area of one or more base stations is divided into information transfer zones. Positioning is utilized in the division into information transfer zones to determine capacity requirements and/or to determine the topography of the network for actual routing. The basics of the division into information transfer zones are described with reference to FIG. 5. In FIG. 5, a large circle 500 denotes a base station whose coverage area is divided into information transfer zones. In FIG. 5, lines 502, 504, 506, and 508 denote the borders of the information transfer zones. It is obvious that, in reality, the borders of the zones are not straight lines as shown in the figure, but the lines wind because of terrestrial obstacles, for example. Antenna technology also sets its limitations.

The size and number of information transfer zones vary application-specifically. The size and number of information transfer zones are influenced by interference in the system and capacity requirements, for example. The aim is to restrict the size of information transfer zones sufficiently small to reduce interference, so that the transmission is directed to a narrow sector in the coverage area. On the other hand, the size of the zones is limited by the required information transfer capacity. The division into information transfer zones can be implemented either when the network is set up and/or dynamically by adjusting the number and size of information transfer zones to the circumstances. In FIG. 5, for the sake of clarity, the base station under study is distinguished from the other radio devices by a larger symbol, the other devices being denoted by small circles in the figure. The difference in the sizes of the symbols does not refer to a difference in the size or importance of the devices. The coverage areas of all devices in the radio network are preferably divided into information transfer zones when a routing method based on information transfer zones is used. However, the division is application-specific. For the sake of clarity, the figure shows the division for only one base station. It is to be noted that the information transfer zones of the base stations may also be at least partly overlapping, should the coverage areas overlap.

In block 404, code families are set on information transfer zones, the codes belonging to the families indicating the information transfer zone. Each information transfer zone is assigned a family, whose number of codes varies according to the need. Code families are mutually orthogonal. The codes within code families are also selected orthogonal to minimize interference. The number of orthogonal codes is limited, which, however, in practice, often means that the requirement for inter-family orthogonality has to be compromised on. In the case of a code division multiple access system, the codes indicating the information zones may also allocate a radio resource. This way, one code may be used both for allocating a radio resource and for routing.

In block 406, an information transfer zone is selected to the transmission so as to optimize the transfer route of the information to be transferred towards the desired receiver. The optimization basis for a transfer route may be for instance the minimization of power consumption in individual devices, a reduction in transfer time, the avoidance of congested transfer routes to even out network load, or a reduction in interference. Power consumption can be minimized by selecting short transfer distances over the radio path. Interference can be reduced by directing the transmission away from congested areas, since then the transmission interferes with as few network users as possible. The operation of the network can be evened out by moving traffic from a congested area to an area having less traffic. Information transfer zones can be identified for instance based on the geographical direction. In this case, the information transfer directions could be for instance a North, South, West and East sector.

In block 408, a code is assigned to the transmission from the code family set on the selected information transfer zone. Using the above geographical example: if the preferred information transfer zone is the North sector, the code for the transmission is selected from the code family indicating the North sector.

In block 410, the information to be transferred is routed by means of the selected code. In routing, a prior art routing algorithm is used. The routing algorithm can be selected, not only according to the information zone, but also according to the application, i.e. for instance according to the data to be transferred. Literature presents routing algorithms suitable for packet data, for instance. Thus, the application in use affects the choice of routing algorithm. Based on the information transfer zone selected, the routing can be implemented for instance by the codes of the code family selected based on the information transfer zone pointing to a routing algorithm directing to the selected base station. In this case, the routing algorithms are typically tabulated. Various routing algorithms are described for instance in publication U.S. Pat. No. 4,939,726 and U.S. Pat. No. 6,236,652, which are incorporated herein by reference.

Applying the above geographical example, the transmission is transmitted towards a base station located in the North sector, seen from the transmission point. Several base stations may also be located in the North sector. In this case, other selection grounds, such as the distance and/or the congestion of the route, may also affect the choice of the most preferable transfer point. The selection can also be made simply using an alternation principle, a transmission being assigned to each base station alternately. There may also be other selection grounds. If the base station that received the transmission is not the actual destination of the transmission, it routes the transmission forward in the above-described manner. In this case, the method is continued in accordance with blocks 406, 408 and 410, denoted in FIG. 4 by arrow 414, until the transmission has reached the final receiver. The entire transfer route may also be selected in advance, but this prevents adaptation to changes in the network during the transfer. Adaptation of the transfer route during propagation from one base station to another allows the changing topology of the network to be taken into consideration.

In addition, in accordance with a second embodiment of the method, in block 412, the transmissions each base station is listening to are determined. By means of the information transfer zones and the coding associated therewith, the base stations only need to listen to relevant transmissions. This leads to speed-up and optimization of the operation, better interference management, lower power consumption and better resource management in the base station serving as the receiver. The information transfer zones can also be used to adjust transmission power and initial set-up transmission power, in particular, according to the need: transmission power can be set in a given direction to a lower level, for instance because of the adjacency of the subscriber terminals and the base stations, or transmission power can be raised in the other direction. Even if the system used an omnidirectional antenna, the above power control, based on information transfer zones, can be used to adjust the transmission power in different directions.

The base stations and/or the subscriber terminals agree upon the code families to be used for instance by using a trunked signalling channel. Trunked signalling channels are in use for instance in many CDMA systems.

FIG. 6 illustrates an example of routing by means of codes indicating information transfer zones. In FIG. 6, base stations are denoted by references 600 to 612. The base stations are either usual devices performing only base station functions or they may also be subscriber terminals attending also to base station functions and even base station controller functions. Of these, base stations 610 and 612 are not on the route of the transmission of the example, and they are shown in the figure to illustrate the network. The transmission is first transmitted based on the desired information transfer zone by means of the selected code and routing algorithm from base station 600 towards base station 602, from where it is further transmitted by means of the selected code and routing algorithm to base station 604. Base station 604 detects that there are two possible transfer routes, 614 and 616. In this particular case, route 614 is selected at the based station, and a code is assigned to the transmission from the code family corresponding to the information transfer zone of route 614. This way the transmission reaches the desired receiver base station 608. In FIG. 6, base station 608 is also the desired destination subscriber terminal, i.e. the message has reached the desired receiver. Otherwise, base station 608 relays the message forward to the desired destination subscriber terminal in accordance with the mode of operation of conventional cellular networks. This enables the combination of different radio network types.

The execution of the method ends at block 418. Arrow 416 describes the repeatability of the method starting from block 402. It is to be noted that the repetition options are only shown by way of example. The method also enables the control of the receivers to listen to a direction, from which a transmission is notified to be incoming.

The invention will be described next with reference to FIG. 7, which shows, for the sake of illustration, a simplified example of a base station transceiver as a block diagram by means of an embodiment. It is apparent to a person skilled in the art that the transceiver can also comprise other parts in addition to those shown in FIG. 7.

Blocks 714 to 720 describe a transmitter and blocks 700 to 706 a receiver. The example of FIG. 7 shows the radio parts of the transmitter and the receiver as separate, but they may also be combined. A signal-processing block 712 describes the hardware parts of the base station required for generating user speech or data in the transmitter. There may be one signal processing block, such as in the example of the figure, or a separate one for the transmitter and the receiver. An information string composed of symbols, i.e. one or more bits, i.e. a signal, is processed in the transmitter in different ways. Signal processing, which includes for instance coding, is usually implemented in a DSP processor (DSP=Digital Signal Processing). If transmission in the system is in frames, the frames being composed of time-slots, the frames are typically generated in the DSP processor, as is symbol interleaving. In accordance with an embodiment, the division into information transfer zones, setting the code families associated with the information transfer zones, assigning codes to the transmissions and/or the selection of a routing algorithm can also be performed in this block.

In block 714, the signal is modulated using the desired modulation method. The aim of signal coding and interleaving is to make sure that the information transmitted can be restored in the receiver, although not every information bit could be received. Block 716 describes multiplication by a spreading code performed on the information to be transmitted in direct sequence spread spectrum systems and used to spread a narrowband signal into wideband. In an embodiment of the invention, the code used in spreading modulation may also be the same as the code indicating the information transfer zone in routing. The signal is converted from digital into analog form in block 718. In RF parts 720, the signal is up-converted to the selected transmission frequency either directly or via an intermediate frequency, amplified and filtered, if necessary. In the example of the figure, the transmitter and the receiver share the same antenna 318, whereby a duplex filter is required to separate a signal to be transmitted and received from one another. The antenna may be an individual antenna or an array antenna composed of several antenna elements.

The receiver comprises RF parts 700, where a received signal is filtered, down-converted either directly to baseband or to an intermediate frequency, and amplified. In block 702, the signal is converted from analog into digital by sampling and quantizing, in block 704, the direct spread wideband signal is despread by multiplication by a code sequence generated by a code generator, in block 706, the effect of the carrier is removed by demodulation, and, in block 712, necessary signal processing is performed, such as deinterleaving, decoding and decryption.

Block 710 is a buffer memory, where location and other data can be stored about the devices belonging to the system at each particular moment.

In a preferred embodiment, the receiver, such as a RAKE type of multi-branched receiver, comprises a delay estimator for estimating the delays of multipath propagated components. The delays of different RAKE branches are set to correspond to the delays of the signal components delayed in various ways.

The base station also comprises a control part 310. In accordance with an embodiment, the base stations perform routing without the control of the base station controller. In this case, the base stations signal, to each other, information relating to routing, for instance, which code families point to which information transfer zones, and to information transfer zone division. In this embodiment, the control part controls for instance the DSP processor or a separate microprocessor as regards the generation of information transfer zones, the generation of code families, the allocation of codes, and the selection of routing algorithm. In this embodiment, base station controllers are used in routing only to transfer signalling information between the base stations. According to a second embodiment of the invention, base stations controllers determine information required in routing, such as the code families used and the information transfer zone division, the control part 310 transferring information relating to code division routing from the base station controllers to the base stations and vice versa. There are other alternative embodiments, for instance different combinations of the two above-described embodiments.

The invention may be implemented not only as a software implementation, but also using hardware solutions offering the required functionality, for instance as an ASIC (Application Specific Integrated Circuit) or by utilizing separate logics components.

Furthermore, in systems that are able to utilize the GPS positioning system, base stations often comprise a locating unit (LMU) or they are able to utilize information transmitted from satellites via a separate locating unit. The locating unit is not shown in FIG. 7, since its location is not relevant to the invention. If the GPS system is utilized in positioning the system devices, the control part 310 can operate as a control unit for the operation of the locating unit and the base station. GPS systems are known art and briefly described above.

In given radio systems, the subscriber terminal 100, 102 itself can operate as the base station, i.e. a radio device whose task is signal transmission to a subscriber terminal and reception from a subscriber terminal. For the sake of clarity, such subscriber terminals are also called base stations in the present application. The structural example of a base station shown in FIG. 7 also describes part of the structure of such a subscriber terminal by way of example. It is apparent to a person skilled in the art that a subscriber terminal also comprises parts required for implementing a user interface, for example. A user interface typically comprises for instance a microphone, a loudspeaker, a keyboard and/or display and, in the future, more often also a camera. These parts are not shown in the figures since they are not relevant to the invention.

Although the invention is described above with reference to examples according to the accompanying drawings, it is apparent that the invention is not limited thereto, but can be modified in a variety of ways within the scope of the inventive idea disclosed in the attached claims.

1. A method of routing transferable information in an information transfer system, the method comprising:
dividing the coverage area of at least one base station into information transfer zones,
setting code families to the information transfer zones, the codes of the code families indicating the information transfer zone,
selecting an information transfer zone for a transmission so as to optimize the transfer route of the transferable information towards a desired receiver,
assigning a code to the transmission from the code family set to the selected information transfer zone, and
routing the transferable information by means of the selected code.

2. A method of routing transferable information in an information transfer system, the method comprising:
dividing the coverage area of at least one base station into information transfer zones,
setting code families to the information transfer zones, the codes of the code families indicating the information transfer zone,
selecting an information transfer zone for a transmission so as to optimize the transfer route of the transferable information towards a desired receiver,
assigning a code to the transmission from the code family set to the selected information transfer zone,
routing the transferable information by means of the selected code, and
determining the transmissions that each base station listens to.

3. The method as claimed in claim 1, wherein the codes allocate information transfer channel resources to different users.

4. The method as claimed in claim 1, wherein the code families are mutually at least substantially orthogonal.

5. The method as claimed in claim 1, wherein the codes within the code families are at least substantially orthogonal.

6. The method as claimed in claim 1, further comprising changing the size of the code families in accordance with capacity requirements.

7. The method as claimed in claim 1, further comprising changing the size of the information transfer zones in accordance with capacity requirements.

8. The method as claimed in claim 1, further comprising changing the number of information transfer zones in accordance with capacity requirements.

9. The method as claimed in claim 1, further comprising changing the size of the information transfer zones to minimize interference.

10. The method as claimed in claim 1, further comprising changing the number of information transfer zones to minimize interference.

11. The method as claimed in claim 1, wherein the grounds for the optimization of the transfer route are the minimization of power consumption.

12. The method as claimed in claim 1, wherein the grounds for the optimization of the transfer route are a reduction in transfer time.

13. The method as claimed in claim 1, wherein the grounds for the optimization of the transfer route are a reduction in interference.

14. The method as claimed in claim 1, wherein the grounds for the optimization of the transfer route are to even out network load.

15. The method as claimed in claim 1, further comprising using the information transfer zones in implementing location data-based routing.

16. The method as claimed in claim 1, wherein the routing is based on the code family division.

17. The method as claimed in claim 1, wherein the transfer route is at least partly based on geographical assignment.

18. The method as claimed in claim 1, wherein the transmission powers of the information transfer zones, and consequently, those of the code families, are adjustable to differ from each other.

19. The method as claimed in claim 1, wherein the information transfer zones are specified based on information obtained about the location of the devices belonging to the radio system.

20. A base station for routing transferable information in an information transfer system, the base station comprising:
means for dividing the coverage area into information transfer zones,
means for setting code families to the information transfer zones, the codes of the code families indicating the information transfer zone,
means for selecting an information transfer zone for a transmission so as to optimize the transfer route of the transferable information towards a desired receiver,
means for assigning a code to the transmission from the code family set to the selected information transfer zone,
means for routing the transferable information by means of the selected code.

21. A base station for routing transferable information in an information transfer system, the base station comprising:
means for dividing the coverage area into information transfer zones,
means for setting code families to the information transfer zones, the codes of the code families indicating the information transfer zone,
means for selecting an information transfer zone for a transmission so as to optimize the transfer route of the transferable information towards a desired receiver,
means for assigning a code to the transmission from the code family set to the selected information transfer zone,
means for routing the transferable information by means of the selected code,
means for determining the transmissions to be listened to.

22. The base station as claimed in claim 21, further comprising means for allocating an information transfer channel resource to different users by means of the codes.

23. The base station as claimed in claim 21, wherein the code families are mutually orthogonal.

24. The base station as claimed in claim 21, wherein the codes within the code families are at least substantially orthogonal.

25. The base station as claimed in claim 21, further comprising means for changing the size of the code families in accordance with capacity requirements.

26. The base station as claimed in claim 21, further comprising means for changing the size of the information transfer zones in accordance with capacity requirements.

27. The base station as claimed in claim 21, further comprising means for changing the number of information transfer zones in accordance with capacity requirements.

28. The base station as claimed in claim 21, further comprising means for changing the size of the information transfer zones to minimize interference.

29. The base station as claimed in claim 21, further comprising means for changing the number of information transfer zones to minimize interference.

30. The base station as claimed in claim 21, further comprising means for optimizing the transfer route to minimize power consumption.

31. The base station as claimed in claim 21, further comprising means for optimizing the transfer route to reduce the transfer time.

32. The base station as claimed in claim 21, further comprising means for optimizing the transfer route to reduce interference.

33. The base station as claimed in claim 21, further comprising means for optimizing the transfer route to even out network load.

34. The base station as claimed in claim 21, further comprising means for using the information transfer zones in implementing location data-based routing.

35. The base station as claimed in claim 21, further comprising means for basing the routing on code family division.

36. The base station as claimed in claim 21, further comprising means for selecting the transfer route at least partly based on geographical assignment.

37. The base station as claimed in claim 21, further comprising means for adjusting the transmission powers of the information transfer zones, and consequently, those of the code families, to differ from each other.

38. The base station as claimed in claim 21, further comprising means for specifying the information transfer zones based on information obtained about the location of the devices belonging to the radio system.

39. A telecommunication system, in which system transferable information is routed, the system comprising:
means for dividing the coverage area into information transfer zones,
means for setting code families to the information transfer zones, the codes of the code families indicating the information transfer zone,
means for selecting an information transfer zone for a transmission so as to optimize the transfer route of the transferable information towards a desired receiver,
means for assigning a code to the transmission from the code family set to the selected information transfer zone,
means for routing the transferable information by means of the selected code.

40. A telecommunication system, in which system transferable information is routed, the system comprising:
means for dividing the coverage area into information transfer zones,
means for setting code families to the information transfer zones, the codes of the code families indicating the information transfer zone,
means for selecting an information transfer zone for a transmission so as to optimize the transfer route of the transferable information towards a desired receiver,
means for assigning a code to the transmission from the code family set to the selected information transfer zone,
means for routing the transferable information by means of the selected code,
means for determining the transmissions to be listened to.

41. The telecommunication system as claimed in claim 39, further comprising means for allocating an information transfer channel resource to different users by means of the codes.

42. The telecommunication system as claimed in claim 39, wherein the code families are mutually orthogonal.

43. The telecommunication system as claimed in claim 39, wherein the codes within the code families are at least substantially orthogonal.

44. The telecommunication system as claimed in claim 39, further comprising means for changing the size of the code families in accordance with capacity requirements.

45. The telecommunication system as claimed in claim 39, further comprising means for changing the size of the information transfer zones in accordance with capacity requirements.

46. The telecommunication system as claimed in claim 39, further comprising means for changing the number of information transfer zones in accordance with capacity requirements.

47. The telecommunication system as claimed in claim 39, further comprising means for changing the size of the information transfer zones to minimize interference.

48. The telecommunication system as claimed in claim 39, further comprising means for changing the number of information transfer zones to minimize interference.

49. The telecommunication system as claimed in claim 39, further comprising means for optimizing the transfer route to minimize power consumption.

50. The telecommunication system as claimed in claim 39, further comprising means for optimizing the transfer route to reduce transfer time.

51. The telecommunication system as claimed in claim 39, further comprising means for optimizing the transfer route to reduce interference.

52. The telecommunication system as claimed in claim 39, further comprising means for optimizing the transfer route to even out network load.

53. The telecommunication system as claimed in claim 39, wherein the information transfer zones are specified based on information obtained about the location of the devices belonging to the radio system.

54. The telecommunication system as claimed in claim 39, further comprising means for using the information transfer zones in implementing location data-based routing.

55. The telecommunication system as claimed in claim 39, further comprising means for basing the routing on code family division.

56. The telecommunication system as claimed in claim 39, further comprising means for selecting the transfer route at least partly based on geographical assignment.

57. The telecommunication system as claimed in claim 39, further comprising means for adjusting the transmission powers of the information transfer zones, and consequently, those of the code families, to differ from each other.

58. The telecommunication system as claimed in claim 39, further comprising means for specifying the information transfer zones based on information obtained about the location of the devices belonging to the radio system.
